(19) United States
(12) Patent Application Publication
(10) Pub. No.: US 2023/0344318 A1
(43) Pub. Date: Oct. 26, 2023

(54) INTEGRATED HIGH SPEED BRUSHLESS DIRECT CURRENT MOTOR

(71) Applicant: SHNZHEN INTELTRON INTELLIGENT SCIENCE & TECHNOLOGY CO., LTD., Shenzhen (CN)

(72) Inventors: Xiaoyong DONG, Shenzhen (CN); Dongqing HUANG, Shenzhen (CN); Yalin RAN, Shenzhen (CN); Chunhui LI, Shenzhen (CN); Bo TANG, Shenzhen (CN)

(21) Appl. No.: 18/097,545

(22) Filed: Jan. 17, 2023

Related U.S. Application Data
(63) Continuation of application No. PCT/CN22/34436, filed on Nov. 25, 2022.

(30) Foreign Application Priority Data
Apr. 25, 2022 (CN) 202220987673.0

(51) Int. Cl. H02K 11/33

(52) U.S. Cl. CPC H02K 11/33; H02K 2211/03

(57) ABSTRACT

The present application relates to a field of motor, in particularly, relates to an integrated high speed brushless DC motor, which includes a main body and a driver. The driver includes a driving board configured for integrating driving components, a control board configured for integrating control components and a wiring board configured for wiring. The driving board is provided at a side of the wiring board away from the stator end of the main body, and the driving board is electrically connected with the wiring board and the control board respectively.

### CROSS-REFERENCE TO RELATED APPLICATION

The present application is a continuation of PCT application No. PCT/CN2022/134436, filed on Nov. 25, 2022, which claims the priority to Chinese patent application No. 202220987673.0, filed on Apr. 25, 2022. The entireties of PCT application No. PCT/CN2022/134436 and Chinese patent application No. 202220987673.0 are hereby incorporated by reference herein and made a part of this specification.

### TECHNICAL FIELD

The present application relates to a field of motor, in particularly, relates to an integrated high speed brushless direct current (DC) motor.

### BACKGROUND ART

A brushless DC motor consists of a motor body and driver, and is a typical mechatronic product. When using the brushless DC motor, a driving circuit and a control circuit should be provided respectively, so that a precise control of the brushless DC motor can be realized during practical use.

When using the high speed brushless DC motor, it is needed to adjust parameters of the driving circuit of the brushless DC motor. Therefore, it is inconvenient for use and needs to be further improved.

### SUMMARY

In order to directly electrically connect the control board to make it more convenient for use, the present application provides an integrated high speed brushless DC motor.

The present application provides the integrated high speed brushless DC motor, adopting the following technical solutions:

The integrated high speed brushless DC motor, includes a main body and a driver; the driver includes a driving board configured for integrating driving components, a control board configured for integrally controlling components, and a wiring board configured for wiring; the wiring board is provided at a stator end of the main body, and the driving board is provided at a side of the wiring board away from the stator end of the main body, and the driving board is electrically connected with the wiring board and the control board respectively.

In the above technical solutions, during a practical use of the brushless motor provided in the present application, by integrating the driving components of the driver on the driving board, and integrating control components on the control board, on one hand, a driving circuit can be preset on the driving board, compared with conventional high speed brushless DC motor, there is no need to additionally provide the drive circuit to drive the motor, and it is more convenient for use by electrically connecting the control board; on the other hand, the driving components are detachably assembled, so that there is a low influence on the control components during the process of the driving components generating heat, and contact areas between all of the driving components and air are increased, so as to improve a heat dissipation efficiency of the driving components at the driving board, and further improve the heat dissipation efficiency of the brushless motor.

In some embodiments, the driver further includes the control board configured for integrating control components, and the driving board is electrically connected with the control board.

In the above technical solutions, during the use of the brushless motor, the motor can be controlled by using the provided control board.

In some embodiments, a plane where the driving board is located is parallel to an extending direction from the stator end of the main body towards the wiring board.

In the above technical solutions, when the brushless DC motor is applied to a device such as a fan and a draught fan, a wind blowing direction of the device is in an extending direction from the stator end of the brushless motor towards the wiring board. For the brushless motor provided in the present application, the plane where the driving board is located is parallel to the extending direction from the stator end of the main body towards the wiring board, thus the driving components provided at the driving board is in the wind blowing direction of the device, so that the device can be used to cool the brushless motor to improve the heat dissipation efficiency of the brushless motor.

In some embodiments, a side of the driving board towards the wiring board is provided with an extended mounting section, and the wiring board is provided with a bar shaped groove configured for an insertion of the extended mounting section.

In the above technical solutions, in order to assemble the driving board with the main body, the extended mounting section at the driving board is inserted into the bar shaped groove. On one hand, the driving board can be fixedly connected with the main body; on the other hand, it can help keep the plane where the driving board is located parallel to the extending direction from the stator end of the main body towards the wiring board.

In some embodiments, the extended mounting section is provided with a first conductive layer, and a second conductive layer is provided at a position at an inner wall of the bar shaped groove corresponding to the position of the first conductive layer; after the extended mounting section is inserted into the bar shaped groove, the first conductive layer is electrically connected with the second conductive layer.

In the above technical solutions, after the extended mounting section is inserted into the bar shaped groove, the first conductive layer abuts against the second conductive layer, so that an electric connection between the driving board and the wiring board can be realized.

In some embodiments, a mounting hole penetrates through the extended mounting section, and a conductive patch is provided in the mounting hole, and the first conductive layer is formed by the conductive patch.

In the above technical solutions, when connecting the conductive patch to the extended mounting section, the provided mounting hole provides a fixed position for the conductive patch at the extended mounting section.

In some embodiments, a surface of the driving board is provided with an interface terminal configured for connecting the driving board with an external circuit.

In the above technical solutions, during a whole assembly process of the brushless motor, by using the interface terminal welded at the driving board, a row of wires at the control board can be plugged into the interface terminal, so as to electrically connect the driving board with the control board.

In some embodiments, a through hole configured for welding a stator end winding of the main body penetrates trough the wiring board.

In the above technical solutions, when fixedly connecting the wiring board with the stator of the main body, the stator end winding of the main body can be welded in the through hole of the wiring board, so as to fix the wiring board.

In summary, the present application has at least one of the following technical features:

1. during the practical use of the brushless motor provided in the present application, by integrating the driving components of the driver on the driving board, and integrating control components on the control board, on one hand, the driving circuit can be preset on the driving board, compared with conventional high speed brushless DC motor, there is no need to additionally provide the drive circuit to drive the motor, and it is more convenient for use by electrically connecting the control board; on the other hand, the driving components are detachably assembled, so that there is the low influence on the control components during the process of the driving components generating heat, and the contact areas between all of the driving components and air are increased, so as to improve a heat dissipation efficiency of the driving components at the driving board, and further improve the heat dissipation efficiency of the brushless motor.

2. the brushless motor can be cooled by using the device, so as to improve the heat dissipation efficiency of the brushless motor.

3. the provided extended mounting hole and the bar shaped groove can make the plane where the driving board is located parallel to the extending direction from the stator end of the main body towards the wiring board.

### BRIEF DESCRIPTION OF THE DRAWINGS

FIG. 1 is a diagram of the structure of an integrated high speed brushless DC motor in embodiments of the present application;

FIG. 2 is an exploded view of a wiring board and a driving board of the integrated high speed brushless DC motor in embodiments of the present application;

FIG. 3 is an enlarged view of part A in FIG. 2 of embodiments of the present application.

### REFERRING SIGNS

1 main body; 2 driving board; 3 wiring board; 4 through hole; 5 extended mounting section; 6 bar shaped groove; 8 second conductive layer; 9 mounting hole; 10 conductive patch; 11 interface terminal.

### DETAILED DESCRIPTION

The present application is further described in detail below.

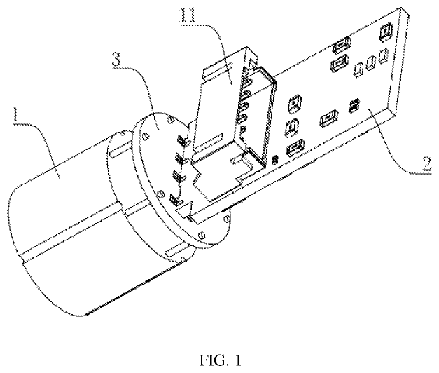

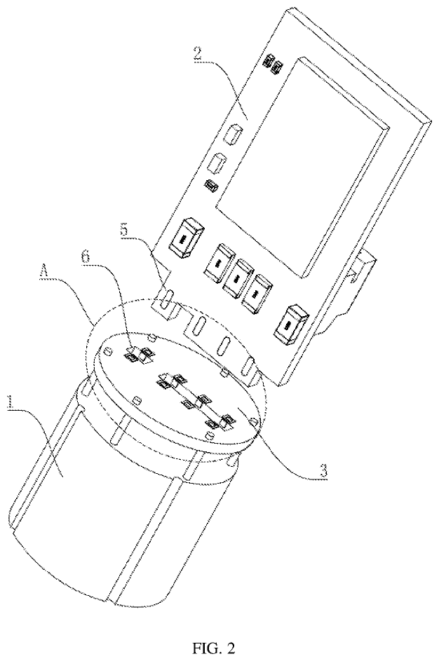

The integrated high speed brushless DC motor, referring to FIG. 1 and FIG. 2, includes a main body 1 and a driver. In embodiments of the present application, the driver includes a driving board 2 configured for integrating driving components, a control board (not shown in figures) configured for integrating control components and a wiring board 3 configured for wiring. A driving circuit of the brushless motor can be preset on the driving board 2, and during a subsequent use of the motor, there is no need to additionally provide the driving circuit to drive the motor. The wiring board 3 is mounted at a stator end of the main body 1. For a conventional uniaxial motor, only one end is provided with an output shaft connected to a rotor. In the present application, the stator end refers to an end of the uniaxial motor opposite to an end provided with the output shaft.

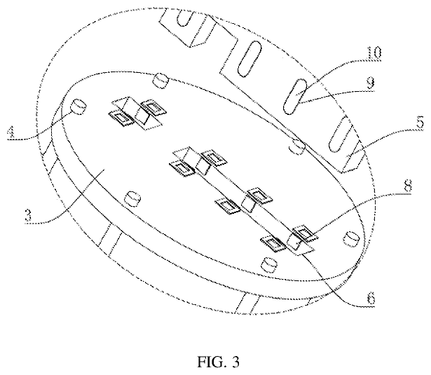

Referring to FIG. 2 and FIG. 3, in order to fix the wiring board 3, the wiring board 3 is provided with multiple through holes 4, penetrating trough the wiring board 3 and configured for welding a stator end winding of the main body 1. In the present application, the wiring board 3 is provided with six through holes 4, and the winding is welded at the wiring board 3 to fixedly connect the wiring board 3 with the stator. The driving board 2 is fixedly connected at a side of the wiring board 3 away from the stator end of the main body 1. The control board and the driving board 2 are detachably assembled, and the driving board 2 is electrically connected with the wiring board 3 and the control board respectively.

The driving components are integrated on the driving board 2, and the control components are integrated on the control board, and the driving board 2 and the control board are detachably assembled. Therefore, there is a low influence on the control components during a process of the driving components generating heat, and contact areas between all of the driving components and air are increased, so as to improve a heat dissipation efficiency of the driving components at the driving board 2.

Additionally, when the brushless DC motor is applied to a device such as a fan and a draught fan, a wind blowing direction of the device is in an extending direction from the stator end of the brushless motor towards the wiring board 3, thus the heat dissipation efficiency of the brushless DC motor can be improved.

A plane where the driving board 2 is located is parallel to the extending direction from the stator end of the main body 1 towards the wiring board 3, and the wind generated by the device can be used to cool the components at a surface of the driving board 2, so as to further improve the heat dissipation efficiency of the motor.

During assembly, referring to FIG. 2 and FIG. 3, in order to keep the plane where the driving board 2 is located parallel to the extending direction from the stator end of the main body 1 towards the wiring board 3, an extended mounting section 5 is integrally formed at a side of the driving board 2 towards the wiring board 3, and a bar shaped groove 6 configured for an insertion of the extended mounting section 5 penetrates through the wiring board 3. By inserting the extended mounting section 5 at the driving board 2 into the bar shaped groove 6, the driving board 2 can be fixed in the extending direction from the stator end of the main body 1 towards the wiring board 3.

Also, after the driving board 2 is fixed, it is necessary to ensure an electrical connection between the driving board 2 and the wiring board 3. Thus, a first conductive layer is provided at a side surface of the extended mounting section 5 towards an inner wall of the bar shaped groove 6 in the length direction thereof. Meanwhile, a second conductive layer 8 is provided at a position at the inner wall of the bar shaped groove 6 corresponding to the position of the first conductive layer. In the present application, the second conductive layer 8 is a conductive silver glue. After the extended mounting section 5 is inserted into the bar shaped groove 6 and the driving board 2 is fixed, the first conductive layer abuts against the second conductive layer 8, so that the driving board 2 is electrically connected with the wiring board 3.

In particular, referring to FIG. 3, a mounting hole 9 penetrates through the extended mounting section 5, and a conductive patch 10 is welded in the mounting hole 9. In the present application, the first conductive layer is formed by a side surface of the conductive patch 10 towards the inner wall of the bar shaped groove 6 in the length direction thereof.

Referring to FIG. 1, during the use of the brushless motor, it is necessary to ensure an electrical connection between the control board and the driving board 2. Thus, the surface of the driving board 2 is welded with an interface terminal 11 electrically connected with the driving board 2. When assembling, a row of wires at the control board can be plugged into the interface terminal 11, so as to ensure an overall electrical signal transmission in the brushless motor.

An implementation principle of the embodiments in present application of the integrated high speed brushless DC motor is as follows. During the practical use of the brushless motor provided in the present application, the driving components of the driver are integrated at the driving board 2, and the control components are integrated at the control board, and the plane where the driving board 2 is located is parallel to the extending direction from the stator end of the main body 1 towards the wiring board 3. Therefore, on one hand, the driving circuit can be preset at the driving board 2. Compared with conventional high speed brushless DC motor, there is no need to additionally provide the drive circuit to drive the motor. On the other hand, the driving components and the control components are detachably assembled, so that there is the low effect on the control components during the process of the driving components generating heat, and contact areas between all of the driving components and air are increased, so as to improve the heat dissipation efficiency of the driving components at the driving board 2; in addition, when the brushless DC motor is applied to the device such as the fan and the draught fan, the wind generated by the device can be used to cool the components at the driving board 2, and further improve the heat dissipation efficiency of the brushless motor.

The above are the preferred embodiments of the present application, and does not limit the protection scope of the present application. Therefore, any equivalent changes made according to the structure, shape and principle of the present application should fall within the protection scope of the present application.

What is claimed is:

1. An integrated brushless direct current (DC) motor, comprising a main body and a driver, wherein, the driver comprises a driving board configured for integrating driving components and a wiring board configured for wiring; the wiring board is provided at a stator end of the main body; the driving board is provided at a side of the wiring board away from the stator end of the main body, and the driving board is electrically connected with the wiring board.

2. The integrated brushless DC motor according to claim 1, wherein the driver further comprises a control board configured for integrating control components, and the driving board is electrically connected with the control board.

3. The integrated brushless DC motor according to claim 1, wherein a plane where the driving board is located is parallel to an extending direction of the stator end of the main body towards the wiring board.

4. The integrated brushless DC motor according to claim 1, wherein a side of the driving board towards the wiring board is provided with an extended mounting section, and the wiring board is provided with a bar shaped groove configured for an insertion of the extended mounting section.

5. The integrated brushless DC motor according to claim 4, wherein the extended mounting section is provided with a first conductive layer, and a second conductive layer is provided at a position at an inner wall of the bar shaped groove corresponding to a position of the first conductive layer; and after the extended mounting section is inserted into the bar shaped groove, the first conductive layer is electrically connected with the second conductive layer.

6. The integrated brushless DC motor according to claim 5, wherein a mounting hole penetrates through the extended mounting section, a conductive patch is provided in the mounting hole, and the first conductive layer is formed by the conductive patch.

7. The integrated brushless DC motor according to claim 1, wherein a surface of the driving board is provided with an interface terminal configured for connecting the driving board with an external circuit.

8. The integrated brushless DC motor according to claim 1, wherein a through hole configured for welding a stator end winding of the main body penetrates trough the wiring board.
